(19) United States
(12) Patent Application Publication
(10) Pub. No.: US 2009/0308773 A1
(43) Pub. Date: Dec. 17, 2009

(54) Carton Box for Storage of Disposable Pre-Cut Toilet Paper Tissues

(76) Inventor: Yoram Laor, Beny Brak (IL)

Correspondence Address: Yoram Laor, 35 Avraham Ben David, Bney Brak, 51605, omitted

(21) Appl. No.: 12/480,824

(22) Filed: Jun. 9, 2009

Related U.S. Application Data
(60) Provisional application No. 61/060,667, filed on Jun. 11, 2008.

(51) Int. Cl. B65D 85/62; B26D 3/00

(52) U.S. Cl. 206/449; 29/428; 83/39

(57) ABSTRACT

A cardboard box for storage of disposable pre-cut toilet paper tissues, and a process for producing it. The box includes a cylindrical wall having two ends and at least one window; two covers, each of the cover is disposed on a different end of the cylindrical wall; an inner tube mounted inside the box, and at least one hygienic paper package, located inside the box, and outside of the inner tube.

### REFERENCE TO CROSS-RELATED APPLICATION

This application claims priority to Provisional Application No. 61/060,667, filed on Jun. 11, 2008, herein incorporated by reference in its entirety.

### FIELD OF THE INVENTION

The present invention relates to pre-cut paper tissues, and in particular to a box for storage of disposable pre-cut toilet paper tissues and paper towels that enable removal of a pre-cut piece of paper for use without needing to tear the paper prior to use.

### BACKGROUND OF THE INVENTION

There is a wide variety of packaging of pre-cut paper tissues that enables removal of a single towelette at a time. The packaging of hygienic paper in a long strip of paper rolled onto itself with perforated lines at regular intervals in order to facilitate tearing off pieces of paper for wiping, which are disposed of after use, is the most common type of hygienic paper currently available.

Such rolls of paper can be found in dispensers of suitable sizes such as toilet paper dispensers in toilet rooms and paper towel dispensers near washbowls.

In many cases, the standard packaging of continuous paper in a roll of which pieces can be torn for use is inconvenient or even impossible to use. Seeing as the tearing of the paper in the desired places requires use of both hands, use of such rolls by disabled individuals who are unable to use one hand or individuals with disability with regard to combined use of both hands for this purpose.

Use of such rolls of continuous paper is also problematic for observant Jews, seeing as according to the laws of Judaism, tearing of paper is prohibited during the Shabbat and on hocoversays.

A roll of disposable pieces of hygienic paper is described in U.S. Pat. No. 7,392,917 of Alalu et al., which is incorporated by reference for all purposes as if fully set forth herein.

FIG. 1 of the prior art illustrates a roll of disposable pieces of hygienic paper 10. As shown in the illustration, an inner tube 12 is mounted on an arm 13 with a round section, which is part of the toilet paper dispenser. The pieces of hygienic paper 11, are rolled upon each other with lengthwise overlapping, and can be pulled out one by one, with each one able to be pulled out separately from the others. Seeing as they are not connected to each other, there is no need to tear paper in order to pull them out. This solution has several disadvantages, the main one being the need for rather long pieces of hygienic paper 11 in order to achieve a stable roll. If the pieces of paper used are at the standard size of those used in regular toilet paper rolls, the roll tends to fall apart.

There is thus a widely recognized need for, and it would be highly advantageous to have, boxes for storage of disposable pre-cut toilet paper tissues and paper towels that enable removal of a pre-cut piece of hygienic paper for use without needing to tear the paper prior to use, which enables efficient use also of paper in standard sizes for toilet paper as well as paper towels for hands.

### SUMMARY OF THE INVENTION

The present invention includes a box for storage of disposable pre-cut toilet paper tissues and paper towels that enable removal of a pre-cut piece of paper for use without needing to tear the paper prior to use, and a method of their production.

The box is composed of a cylinder with a wall which has a window or windows, such as two windows facing each other. The cylinder is closed at both ends with covers. The cylinder and the covers are made of material which is thin relative to their other dimension, such as thin cardboard. At the center of the cylinder, around its longitudinal axis is disposed an inner tube whose internal diameter is suitable for use with standard toilet paper or paper towel dispensing devices, as necessary.

The inner tube can be contained within an inner cylinder, which has a section shape similar to a flattened oval. Each one of the spaces between the inner cylinder and the wall of the cylinder and the covers contains one package of hygienic paper. Each such package contains many pieces of hygienic paper with sizes and qualities suitable for their designated use, and they can be folded and arranged in layers and engaged in each others' fold so that pulling the external piece of hygienic paper will result in the following piece of hygienic paper starting to come out.

The production process can include use of raw materials in suitable sizes for the manufacture of a long cylinder containing all of the required internal components, cutting them, and closing them off with covers.

According to the present invention there is provided a box for storage of disposable pre-cut toilet paper tissues and paper towels, the box including: (a) a cylindrical wall having two ends and at least one window; (b) two covers, each of the cover is disposed on a different end of the wall; and (c) an inner tube mounted inside the box.

According to still further features in the described embodiments the box contains al least one hygienic paper package, the hygienic paper package is located inside the box, and outside of the inner tube.

According to still further features in the described embodiments, the box contains two hygienic paper packages, each of the hygienic paper packages is located inside the box, and outside of the inner tube.

According to still further features in the described embodiments, the box for storage of disposable pre-cut toilet paper tissues and paper towels further includes: an inner cylinder, mounted inside the box, and outside of the inner tube, wherein the inner cylinder has an oblate cross section shape.

According to still further features in the described embodiments, the box contains al least one hygienic paper package, the hygienic paper package is located inside the box, and outside of the inner cylinder.

According to still further features in the described embodiments, the box contains two hygienic paper packages, each of the hygienic paper package is located inside the box, and outside of the inner cylinder.

According to the present invention there is provided a process for producing a box which contains disposable pre-cut hygienic paper, the process including: laying at least one raw hygienic paper package, and an inner cylinder raw material, on a wall raw material, wherein the wall raw material has at least one row of windows; and bending the wall raw material, and connecting two ends of the wall raw material, to give a cylindrical shape to the wall raw material.

According to still further features in the described embodiments the process for producing a box which contains disposable pre-cut hygienic paper, further including: cutting the cylindrical wall raw material, the inner cylinder raw material, and the at least one raw hygienic paper package, wherein each cut is done between two neighboring windows of the wall raw material.

According to still further features in the described embodiments the process for producing a box which contain disposable pre-cut hygienic paper, further including: (c) disposing a cover at each of two ends of the cylindrical wall.

According to still further features in the described embodiments the process for producing a box which contains disposable pre-cut hygienic paper, each of the covers has at least one cover arm, wherein each of the cover arms is bent by an apparatus having a hole.

According to still further features in the described embodiments each of the covers has at least one cover arm, wherein each of the cover arms is glued to the cylindrical wall and fastened by a clamp.

According to still further features in the described embodiments the process for producing a box which contains disposable pre-cut hygienic paper, further including: (d) before the connecting of the two ends of the wall raw material, laying the inner cylinder raw material inside inner cylinder raw material.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 of the prior art illustrates a roll of disposable pieces of hygienic paper.

FIG. 2 is an isometric schematic illustration of a hand pulling piece of hygienic paper from a box for storage of disposable pre-cut toilet paper tissues and paper towels, according to an exemplary, illustrative embodiment of the present invention.

FIG. 3 is an isometric schematic illustration of wall raw material, according to an exemplary, illustrative embodiment of the present invention.

FIG. 4 is an isometric schematic illustration of wall raw material, according to an exemplary, illustrative embodiment of the present invention.

FIG. 5 is an isometric schematic illustration of wall raw material, on which are placed inner tube raw material, inner cylinder raw material, and two raw hygienic paper packages, according to an exemplary, illustrative embodiment of the present invention.

FIG. 6a is an isometric schematic illustration of wall raw material, as a cylinder with short windows, containing inner tube raw material, inner cylinder raw material, and two raw hygienic paper packages, according to an exemplary, illustrative embodiment of the present invention.

FIG. 6b is an isometric schematic illustration of wall raw material, as a cylinder with long windows, containing inner tube raw material, inner cylinder raw material, and two raw hygienic paper packages, according to an exemplary, illustrative embodiment of the present invention.

FIG. 7 is an isometric schematic illustration of a cutting process, according to an exemplary, illustrative embodiment of the present invention.

FIG. 8 is an isometric schematic illustration of cutting outcome according to an exemplary, illustrative embodiment of the present invention.

FIG. 9 is an isometric schematic illustration of a wall both of whose cut ends are attached to one cover each, according to an exemplary, illustrative embodiment of the present invention.

FIG. 10 is an isometric schematic illustration of a folding stage of the cover arms, according to an exemplary, illustrative embodiment of the present invention.

FIG. 11 is an isometric schematic illustration of an adhesion stage of the cover arms to the wall, according to an exemplary, illustrative embodiment of the present invention.

FIG. 12 is an isometric schematic illustration of a wall raw material, two raw hygienic paper packages, inner cylinder raw material, and inner tube raw material, displayed side-by-side, according to an exemplary, illustrative embodiment of the present invention.

FIG. 13 is an isometric schematic illustration of an end of several pieces of hygienic papers, according to the present invention.

FIG. 14 is a front view schematic illustration of a wall, two hygienic paper packages, an inner cylinder, and an inner tube, packed together according to an exemplary, illustrative embodiment of the present invention.

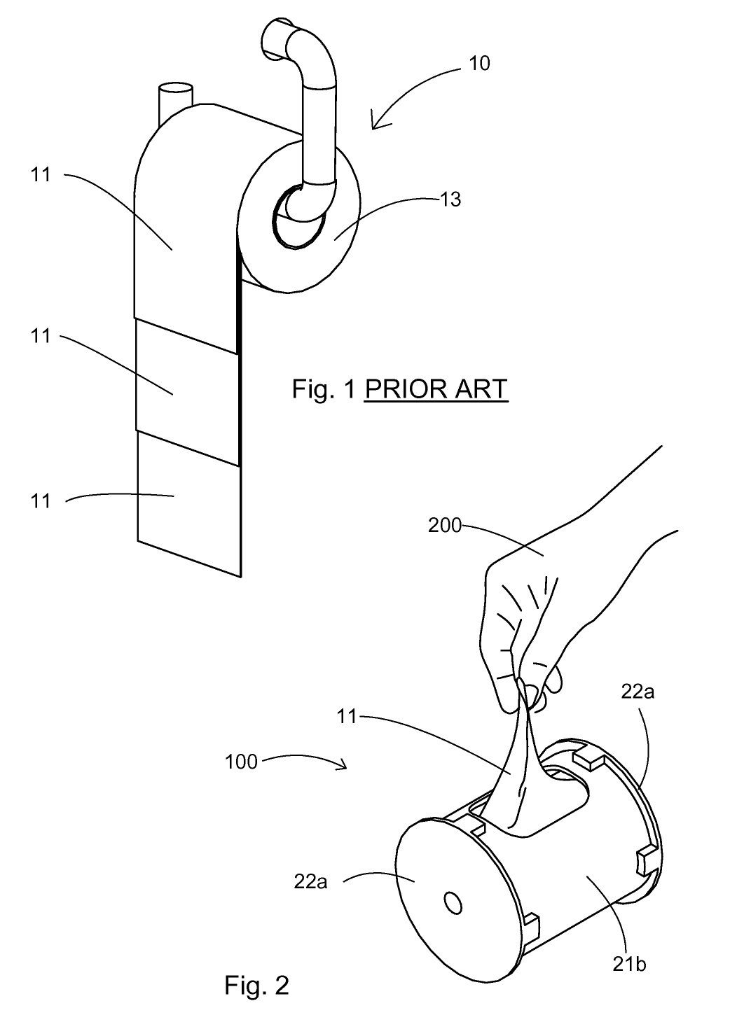

### DETAILED DESCRIPTION OF EMBODIMENTS

The present invention is of a box for storage of disposable pre-cut toilet paper tissues.

The principles and operation of a box for storage of disposable pre-cut toilet paper tissues and their process of production according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
10 roll of disposable pieces of hygienic paper
11 piece of hygienic paper
12 inner tube
13 arm
21a wall raw material
21b wall
22a cover
22b cover arm
23 adhesion line
24 window
25a inner tube raw material
25b inner tube
26a inner cylinder raw material
26b inner cylinder
27a raw hygienic paper package
27b hygienic paper package
30 table
31 disc knife
35 hole
36 clamp
100 box (for storage of disposable pre-cut toilet paper tissues and paper towels)
200 hand

Referring now to the drawings, FIG. 2 is an isometric schematic illustration of a hand 200 pulling a piece of hygienic paper 11 from a box 100 for storage of disposable pre-cut toilet paper tissues and paper towels, according to an exemplary, illustrative embodiment of the present invention. The pulling is done without any tearing, and can be done easily with one hand. Box 100 can be manufactured in dimensions to enable use with many existent devices such as dispensers for carrying rolls of toilet paper or rolls of paper towels for hands.

The present illustration shows a wall 21b and two covers 22a, of box 100. The widths are exaggerated for the purpose of illustration, while they can actually be made of thin cardboard or any other thin suitable material. This also applies to additional illustrations in the present patent application, as well as the thickness of the hygienic paper.

The following illustrations show the product, the box, and the disposable pre-cut toilet paper tissues and paper towels that enable removal of a pre-cut piece of paper for use without needing to tear the paper prior to use, as well as a possible process for their production and packaging.

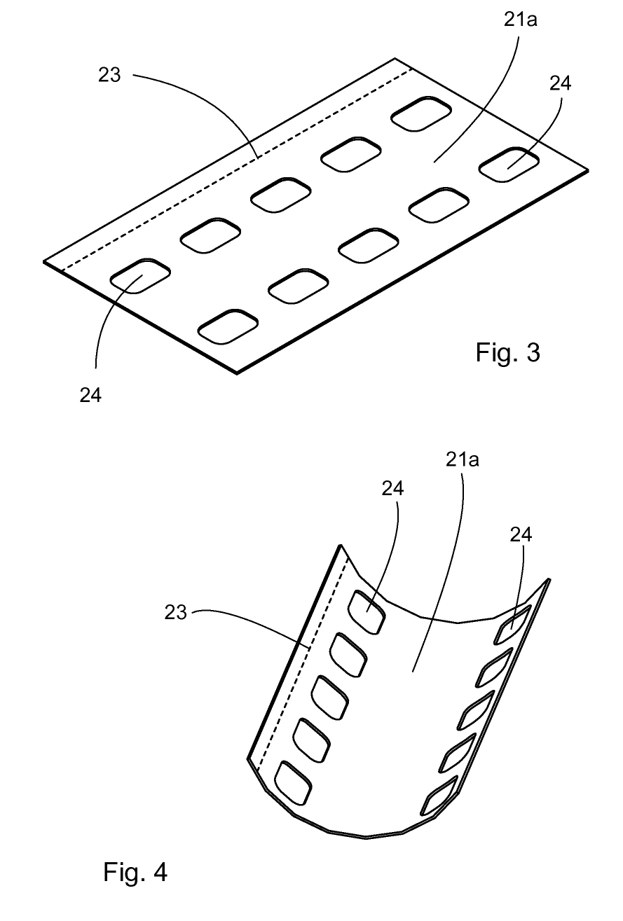

FIG. 3 is an isometric schematic illustration of wall raw material 21a, according to an exemplary, illustrative embodiment of the present invention.

The wall raw material 21a in its initial state can be a flat sheet of a thin and strong material, upon which an adhesion line 23 can be marked for facilitation of later stages, including two rows of windows 24.

FIG. 4 is an isometric schematic illustration of wall raw material 21a, according to an exemplary, illustrative embodiment of the present invention. The manufacturing process starts with bending the wall raw material 21a as shown in the present illustration, with the purpose of bending it into a cylinder.

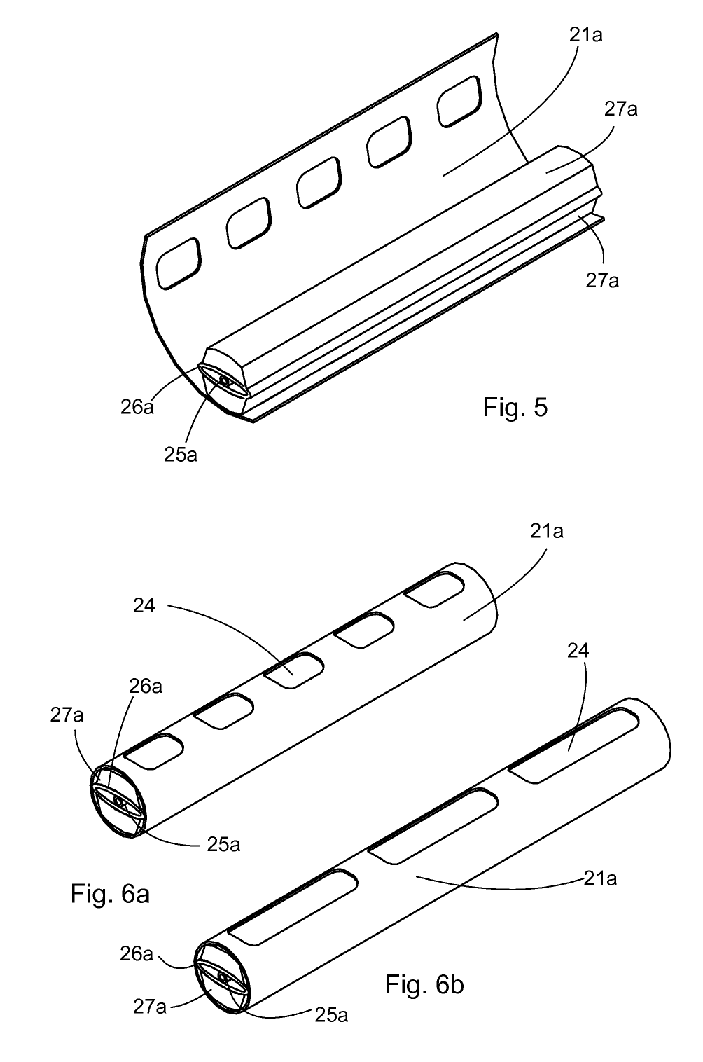

FIG. 5 is an isometric schematic illustration of wall raw material 21a, upon which are placed inner tube raw material 25a, inner cylinder raw material 26a, and two raw hygienic paper packages 27a, as shown in the present illustration, according to an exemplary, illustrative embodiment of the present invention. The final product can also be without inner cylinder raw material 26a, which serves here for outward fastening of the two raw hygienic paper packages 27a. The internal diameter of the inner tube raw material 25a is suitable for use with standard devices.

The two raw hygienic paper packages 27a contain many layers of sheets of hygienic paper. Each sheet is folded into two lengthwise and is engaged in its adjacent sheets as shown in detail in FIG. 13.

FIG. 6a is an isometric schematic illustration of wall raw material 21a, as a cylinder with short windows 24 containing inner tube raw material 25a, inner cylinder raw material 26a, and two raw hygienic paper packages 27a, according to an exemplary, illustrative embodiment of the present invention. At this stage, the bending of the wall raw material 21a has been completed and the edges along the adhesion line 23 have been glued. The sizes of the short windows 24 are suitable for pulling out toilet paper.

FIG. 6b is an isometric schematic illustration of wall raw material 21a, as a cylinder with long windows 24, containing inner tube raw material 25a, inner cylinder raw material 26a, and two raw hygienic paper packages 27a, according to an exemplary, illustrative embodiment of the present invention. At this stage, the bending of the wall raw material 21a has been completed and the edges along the adhesion line 23 have been glued. The sizes of the long windows 24 are suitable for pulling out paper towels for hands.

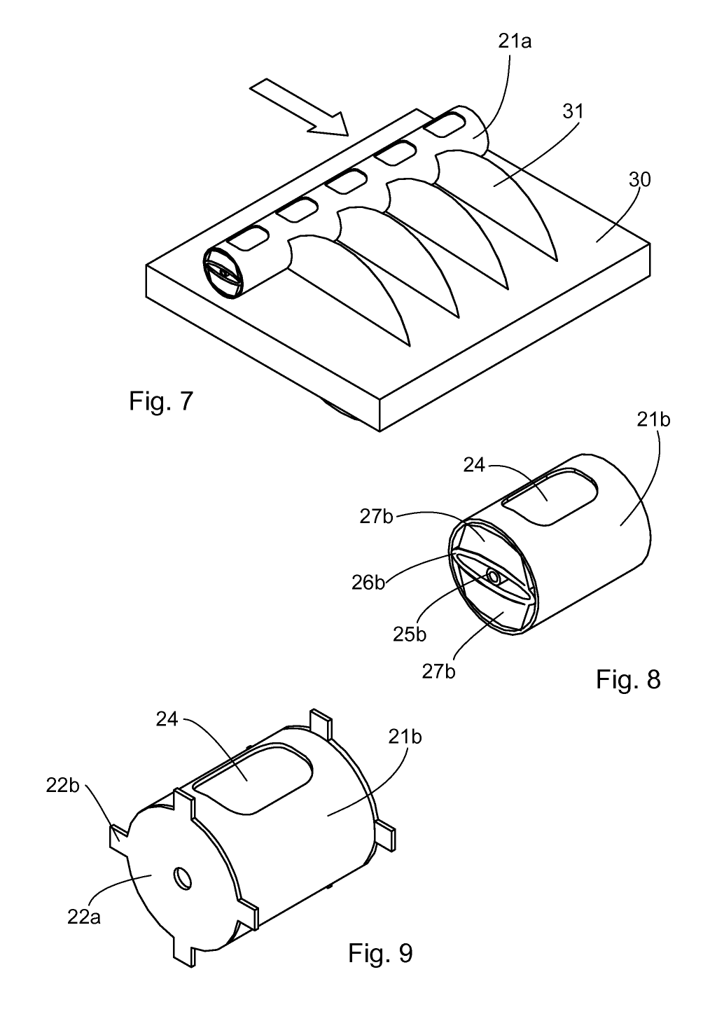

FIG. 7 is an isometric schematic illustration of a cutting process, according to an exemplary, illustrative embodiment of the present invention. At this stage, the wall raw material 21a and all of its contents are cut at regular intervals, as shown in the present illustration. The cutting can be done in many different ways, one of which is shown here, with wall raw material 21a placed upon table 30 and is moved upon it so that a series of rotating disc knifes 31 performs.

FIG. 8 is an isometric schematic illustration of a cutting outcome, according to an exemplary, illustrative embodiment of the present invention. The outcome is a wall 21b with a pair of windows 24 one of which is shown in the present illustration, containing an inner tube 25b, an inner cylinder 26b, and two hygienic paper packages 27b.

FIG. 9 is an isometric schematic illustration of a wall 21b both of whose cut edges have one cover 22a attached each, according to an exemplary, illustrative embodiment of the present invention. Each one of the covers 22a has several cover arms 22b designated for use for gluing to wall 21b.

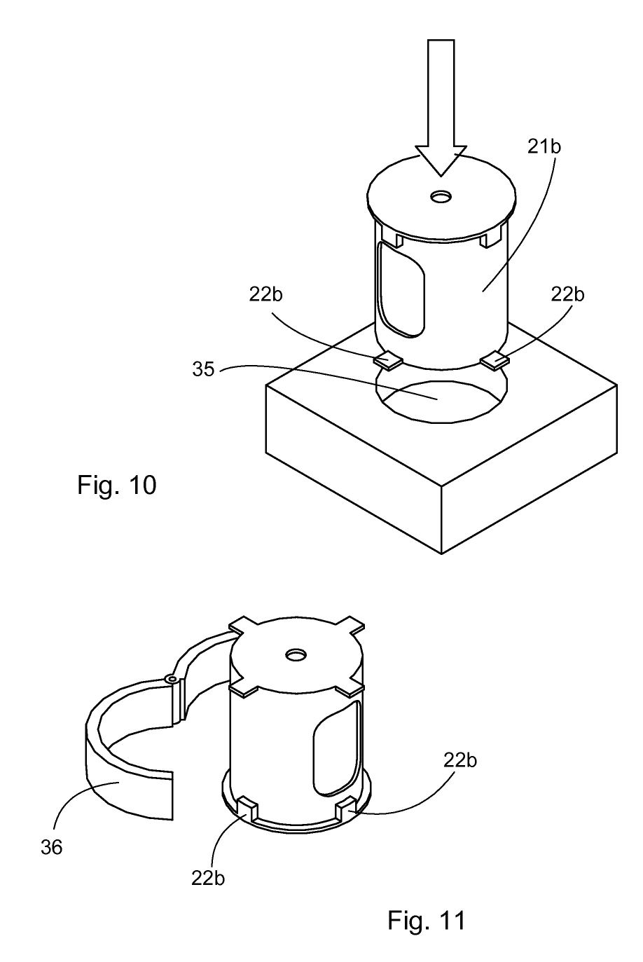

FIG. 10 is an isometric schematic illustration of a stage of folding the cover arms 22b, according to an exemplary, illustrative embodiment of the present invention. After applying adhesive, the folding can be done in many various ways, also as shown in the present illustration, by inserting wall 21b which has a cover 22a at its end, with two of its cover arms 22b shown in the illustration, into a hole 35 of a suitable diameter.

FIG. 11 is an isometric schematic illustration of an adhesion stage of the cover arms 22b to the wall 21b, according to an exemplary, illustrative embodiment of the present invention. Fastening, for the purpose of strong adhesion, can be done in many various ways, also as shown in the present illustration by means of a clamp 36.

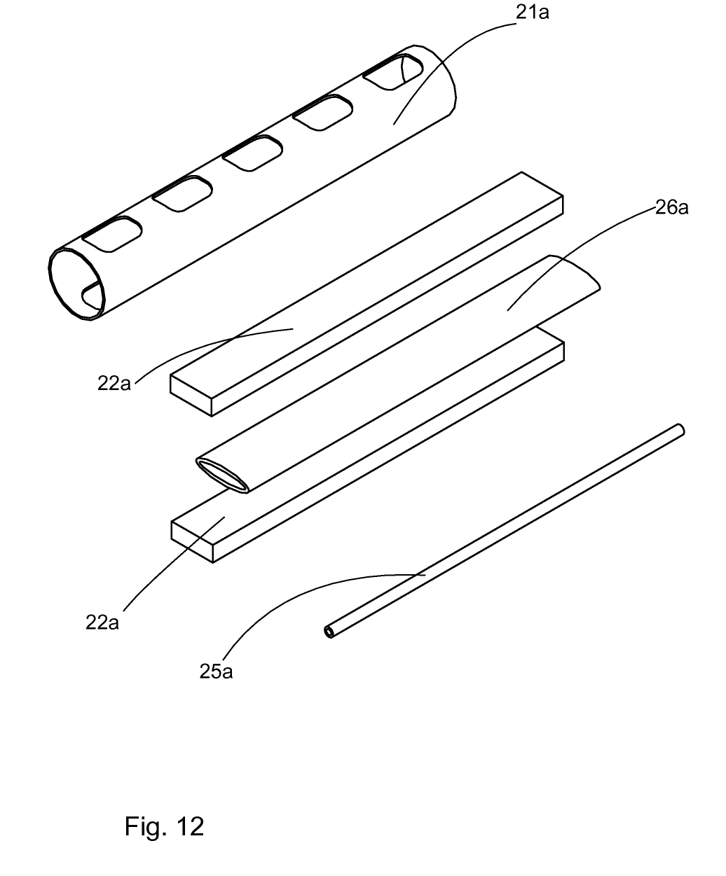

FIG. 12 is an isometric schematic illustration of wall raw material 21a, two raw hygienic paper packages 27a, inner cylinder raw material 26a, and inner tube raw material 25a displayed side by side, according to an exemplary, illustrative embodiment of the present invention.

FIG. 13 is an isometric schematic illustration of ends of several pieces of hygienic papers 11, according to an exemplary, illustrative embodiment of the present invention. The present illustration, and particularly the magnified circle on its left side, show how each piece of paper is folded into two lengthwise and engaged in its adjacent pieces of paper. This configuration ensures that when pulling the paper, part of the following piece of paper will also be pulled out so it will be easy to completely pull out when desired. This folding method is one of many various possible folding methods, and its description is in no way meant to limit the present invention.

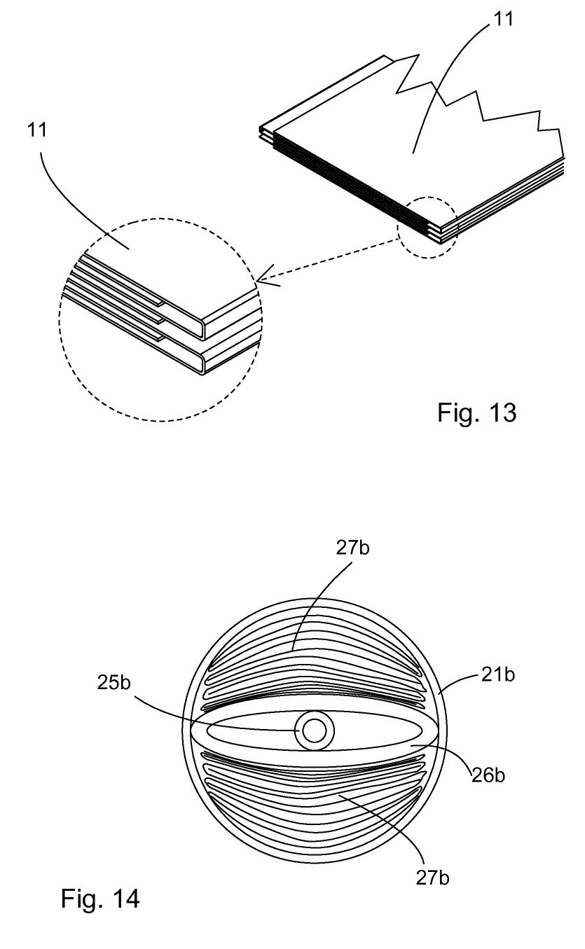

FIG. 14 is a front view schematic illustration of a wall 21b, two hygienic paper packages 27b, an inner cylinder 26b, and an inner tube 25b, packed together according to an exemplary, illustrative embodiment of the present invention.

While the invention has been described with respect to a limited number of embodiments, it will be appreciated that many variations, modifications and other applications of the invention may be made.

What is claimed is:

1. A box for storage of disposable pre-cut toilet paper tissues and paper towels, the box comprising:
(a) a cylindrical wall having two ends and at least one window;
(b) two covers, each of said cover is disposed on a different end of said wall; and
(c) an inner tube mounted inside said box.

2. The box for storage of disposable pre-cut toilet paper tissues and paper towels of claim 1, wherein said box contains al least one hygienic paper package, said hygienic paper package is located inside said box, and outside of said inner tube.

3. The box for storage of disposable pre-cut toilet paper tissues and paper towels of claim 1, wherein said box contains two hygienic paper package, each of said hygienic paper package is located inside said box, and outside of said inner tube.

4. The box for storage of disposable pre-cut toilet paper tissues and paper towels of claim 1 further comprising:
(e) an inner cylinder, mounted inside said box, and outside of said inner tube, wherein said inner cylinder has an oblate cross section shape.

5. The box for storage of disposable pre-cut toilet paper tissues and paper towels of claim 4, wherein said box contains al least one hygienic paper package, said hygienic paper package is located inside said box, and outside of said inner cylinder.

6. The box for storage of disposable pre-cut toilet paper tissues and paper towels of claim 4, wherein said box contains two hygienic paper packages, each of said hygienic paper packages is located inside said box, and outside of said inner cylinder.

7. A process for producing a box which contain disposable pre-cut hygienic paper, said process comprising:
(a) laying at least one raw hygienic paper package, and inner cylinder raw material, on wall raw material, wherein said wall raw material has at least one row of windows; and
(b) bending said wall raw material, and connecting two ends of said wall raw material, to give a cylindrical shape to said wall raw material.

8. The process for producing a box which contains disposable pre-cut hygienic paper, of claim 7, further comprising:
(d) cutting said cylindrical wall raw material, said inner cylinder raw material, and said at least one raw hygienic paper package, wherein each cut is done between two neighboring windows of said wall raw material.

9. The process for producing a box which contains disposable pre-cut hygienic paper, of claim 8, further comprising:
(c) disposing a cover at each of two ends of said cylindrical wall.

10. The process for producing a box which contain disposable pre-cut hygienic paper, of claim 9, wherein each of said covers has at least one cover arm, wherein each of said cover arms is bent by an apparatus having a hole.

11. The process for producing a box which contain disposable pre-cut hygienic paper, of claim 9, wherein each of said covers has at least one cover arm, wherein each of said cover arms is glued to said cylindrical wall, and fastened by a clamp.

12. The process for producing a box which contain disposable pre-cut hygienic paper, of claim 8, and further comprising:
(d) before said connecting of said two ends of said wall raw material, laying said inner cylinder raw material inside an inner cylinder raw material.

13. The process for producing a box which contains disposable pre-cut hygienic paper, of claim 9, and further comprising:
(d) before said connecting of said two ends of said wall raw material, laying said inner cylinder raw material inside inner cylinder raw material.
